(19) United States
(12) Patent Application Publication
(10) Pub. No.: US 2007/0047858 A1
(43) Pub. Date: Mar. 1, 2007

(54) Foil journal bearing with bilinear stiffness spring

(75) Inventors: Keith A. Hurley, Garden Grove, CA (US); Marshall Saville, Torrance, CA (US); Alan Kang, Los Angeles, CA (US); Aileen C. Yap, Rancho Palos Verdes, CA (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC.

(21) Appl. No.: 11/408,430

(22) Filed: Apr. 20, 2006

Related U.S. Application Data
(60) Provisional application No. 60/713,253, filed on Aug. 31, 2005.

(51) Int. Cl. F16C 32/06

(52) U.S. Cl. 384/106

(57) ABSTRACT

A foil journal bearing with a dual stiffness spring comprises a housing, a shaft arranged for relative coaxial rotation with respect to the housing, and a single spring layer surrounding the shaft. The single spring layer may have a first linear spring rate and a second linear spring rate wherein the first linear spring rate is formed by first pitch corrugations along a length of the single spring layer and the second linear spring rate is formed by second pitch corrugations along a length of the single spring layer. In an aspect of the invention, the foil journal bearing provides a top foil having first and second ends positioned in a notch in the housing. In an aspect of the invention, the single spring layer maintains a ratio of three of the second pitch corrugations to each of the first pitch corrugations.

### CROSS-REFERENCE TO PRIOR APPLICATION

This application claims benefit under 35 U.S.C. § 119(e) of U.S. Provisional Application having Ser. No. 60/713,253 filed Aug. 31, 2005, which is hereby incorporated by reference herein in its entirety.

### BACKGROUND OF THE INVENTION

The present invention relates generally to a foil journal bearing having a single spring layer with two linear spring rates to enhance pre-load damping while maintaining low start torque, and more particularly to a foil journal bearing having a single spring layer with superimposed fine and coarse pitch corrugations along a length of the spring layer.

Fluid film bearings are used in many diverse applications requiring high speed rotating turbo-machinery. A fluid film bearing generally comprises two relatively movable elements separated by a thin film of fluid lubricant, such as air. For example, a fluid film bearing may comprise a stationary bushing that encompasses a rotating shaft journal, having predetermined radial clearance therebetween, filled with the fluid lubricant. Hydrodynamic fluid film bearings utilize the relative sliding motion between the movable elements to generate fluid pressure in the lubricant film sufficient to separate the relatively movable elements. The minimum relative sliding velocity required to separate the elements is commonly referred to as the “lift-off speed” and the shaft torque required to accelerate the shaft to the lift-off speed is referred to as the “start torque”. At speeds slightly above the lift-off speed the torque required to maintain separation of the elements drops dramatically.

Hydrodynamic fluid film foil bearings have been developed by replacing the traditional rigid bearing surface with a compliant structure built up of thin foil sheets. For example, a foil journal bearing may comprise a smooth foil sheet or “top foil” that wraps around the outside diameter of a shaft journal, is anchored to the bore of a rigid bearing housing that encompasses the journal and top foil, and is supported on a resilient spring layer between the top foil and the bearing housing. The spring layer may comprise a corrugated foil that wraps around the outside of the smooth top foil and is also anchored to the bore of the bearing housing. Advantages of these compliant surface bearings include improved tolerance to bearing misalignment and centrifugal and thermal shaft growth. In addition, Coulomb friction at contacting points within the compliant structure offers improved damping over rigid surface fluid film bearings.

Critical foil bearing performance requirements generally include low lift-off speed, low start torque, dynamic stability, and high load capacity. The radial stiffness of the radial-type foil bearings must be large enough to prevent excessive radial motion of the rotating assembly relative to the housing under static and/or dynamic load conditions. Typical maximum allowable radial excursions of the rotating assembly in a turbo-machinery application are on the order of only 0.005 to 0.010 inch.

If the annular gap between the journal and housing surfaces is less than the thickness of the compliant structure (top foil thickness plus the free height of the spring) then the bearing spring will be pre-loaded. Pre-load of foil bearing springs can be used to obtain/enhance damping and associated dynamic stability of the rotor/bearing system. Damping generally increases with increased spring pre-load. Unfortunately, increasing the pre-load also tends to increase the start torque and lift off speed. Very light or even slightly negative pre-load (gap is slightly greater than the thickness of the compliant structure) may be used to obtain low start torque and lift off speed, but dynamic in-stability due to insufficient damping may result.

By selection of design parameters, such as shaft and bearing housing bore diameters, the bearing engineer attempts to obtain a design pre-load that will provide high damping yet minimize start torque and lift-off speed. The high stiffness of conventional foil bearing springs, coupled with natural manufacturing variation in bearing housing bore and shaft dimensions, makes it difficult to consistently achieve the correct pre-load in high volume production. Extremely tight dimensional tolerance specifications and match-setting of parts are commonly used solutions to this problem but these methods generally result in high manufacturing costs and/or increased scrap rates.

U.S. Pat. No. 6,964,522 provides a high load capacity hydrodynamic journal foil bearing system employing a plurality of undersprings and multiple layers to provide different effective spring rates. The single piece top foil has abutting leading and trailing edges to prevent high spring pre-load from being transferred to the shaft. However, if the top foil is too large the gap between the top foil and shaft is too great resulting in little or no damping by the fluid within the gap. This results in dimensional tolerances in the range of only 2-4 thousands of an inch for the length of the top foil.

U.S. Pat. No. 4,295,689 provides a fluid-film journal bearing having a single resilient foil insert assembly comprising a single continuous foil member wrapped repeatedly around a shaft to form a plurality of layers. U.S. Pat. No. 4,295,689 further teaches that one layer of the continuous foil is pre-formed into successive, undulating curves having alternating peaks and valleys. However, this design provides only a single spring layer having a single wave form resulting in a constant single spring rate.

U.S. Pat. No. 4,415,281 discloses an embodiment having a single spring layer utilizing alternating heights of spring corrugations wrapping completely around the shaft and having ends abutting each other. U.S. Pat. No. 4,415,281 also discloses an embodiment having a single spring layer having constant fine and first pitch lengths with abutting ends wrapping a full 360° around the shaft. This design prevents or inhibits high spring pre-load from being transferred to the shaft similar to U.S. Pat. No. 6,964,522. However, the top foil has free ends which permit telescoping of the top foil upon insertion of the shaft. Further, this design lacks variable pitch along the length of the spring layer preventing optimization of load capacity through shaping of the fluid film shape surrounding the shaft.

As can be seen, there remains a need for an improved foil journal bearing that provides increased transfer of pre-load to enhance damping in the journal bearing while minimizing start-up torque and bearing lift-off speed of the shaft.

### SUMMARY OF THE INVENTION

In one aspect of the present invention, a foil journal bearing system comprises a single spring layer surrounding a shaft; wherein the single spring layer has a first linear spring rate and a second linear spring rate; wherein the first linear spring rate is formed by first pitch corrugations along a length of the single spring layer; wherein the second linear spring rate is formed by second pitch corrugations along a length of the single spring layer; and wherein the single spring layer maintains a ratio of three of the second pitch corrugations to each one of the first pitch corrugations.

In another aspect of the present invention, a foil journal bearing system comprises a housing; a hole capable of receiving a shaft arranged for relative coaxial rotation within the housing; a top foil layer disposed between the housing and the shaft; and a single spring layer positioned between the top foil layer and the housing; the top foil layer having a top foil member, the top foil member having a first end and a second end, the first end and the second end each being positioned within a notch in the housing; wherein the single spring layer has a first linear spring rate and a second linear spring rate wherein the first linear spring rate is formed by first pitch corrugations along a first length of the single spring layer and the second linear spring rate is formed by second pitch corrugations along a second length of the single spring layer; and wherein pitch lengths of the second pitch corrugations and the first pitch corrugations are variable with respect to position along the second and first lengths, respectively, of the spring layer.

In yet another aspect of the present invention, a foil journal bearing system comprises a housing; a shaft arranged for relative coaxial rotation with respect to the housing; and a single spring layer surrounding the shaft, wherein: the single spring layer having a first linear spring rate and a second linear spring rate wherein the first linear spring rate is formed by first pitch corrugations along a length of the single spring layer and the second linear spring rate is formed by second pitch corrugations along a length of the single spring layer; the single spring layer maintains a ratio of three of the second pitch corrugations to each of the first pitch corrugations; the single spring layer comprises a plurality of individual springs arranged in serial alignment around the shaft; and a leading edge of the single spring layer is positioned in spaced relationship to a trailing edge of the single spring layer to form a gap for transmitting spring pre-load to the shaft.

These and other features, aspects and advantages of the present invention will become better understood with reference to the following drawings, description and claims.

### BRIEF DESCRIPTION OF THE DRAWINGS

FIG. 1 is a side sectional view of an embodiment of the present invention;

FIG. 2 is a side sectional view of an alternate embodiment of the present invention;

FIG. 3 is a side sectional view of another alternate embodiment of the present invention;

FIG. 4A is a variable second pitch spring wave according to an embodiment of the present invention;

FIG. 4B is a variable first pitch spring wave according to an embodiment of the present invention;

FIG. 4C is a superimposed wave form combining fine and first pitch waves according to an embodiment of the present invention;

FIG. 5 is a constant fine and first pitch combined wave form having a three to one ratio according to an embodiment of the present invention;

FIG. 6 is variable fine and first pitch combined wave form having a three to one ratio according to an embodiment of the present invention;

FIG. 7 is constant second pitch wave form with and without first pitch superimposition along a length of the spring wave according to an embodiment of the present invention;

FIG. 8 is variable second pitch wave form with and without first pitch superimposition along a length of the spring wave form according to an embodiment of the present invention;

FIG. 9 is a combination of variable and constant second pitch wave forms with and without first pitch superimposition along a length of the spring wave form according to an embodiment of the present invention; and

FIG. 10 is a flow chart of a method of damping vibration in a foil journal bearing with dual stiffness spring according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

The present invention may be used in, but not limited to use in, air cycle machines, turbochargers, auxiliary power units, motor driven compressors, and high-speed turbomachinery.

Briefly, the present invention provides a foil journal bearing having a housing, a shaft, and a single spring layer utilizing first and second pitch corrugations in a three to one ratio to employ dual spring rates within the single spring layer. Unlike the prior art which uses multiple layers of springs stacked in a particular arrangement, this invention offers a bearing spring having a single spring layer utilizing a combination of first and second pitch corrugations in a three to one ratio to produce the dual spring rates. For deflection of the spring up to a given design point the spring rate is relatively small and nearly constant. The bearing pre-load is established with initial spring compression in this range and such that a good balance of damping and low start torque is achieved. Because the spring rate is low, the pre-load (and thus the damping and start torque) does not vary significantly from bearing to bearing due to practical manufacturing variation in design parameters such as bearing housing bore and shaft dimensions. For deflection of the spring above the design point the spring rate is nearly constant but is much higher than the pre-load spring rate. In this region the spring provides the desired high load support stiffness provided by conventional foil bearing springs having a single, high, spring rate. Because a single spring layer is used, a two to one or four to one ratio requires that only one of the pre-load bearing or start-up torque characteristics can be in a typically desired range. The three to one ratio permits use of a single spring layer to provide both pre-load damping and low start-up torque simultaneously. The single spring layer utilizing a three to one ratio for corrugations is less sensitive to natural manufacturing variation, enables specification of more practical dimensional tolerances, and does not require match-setting of parts.

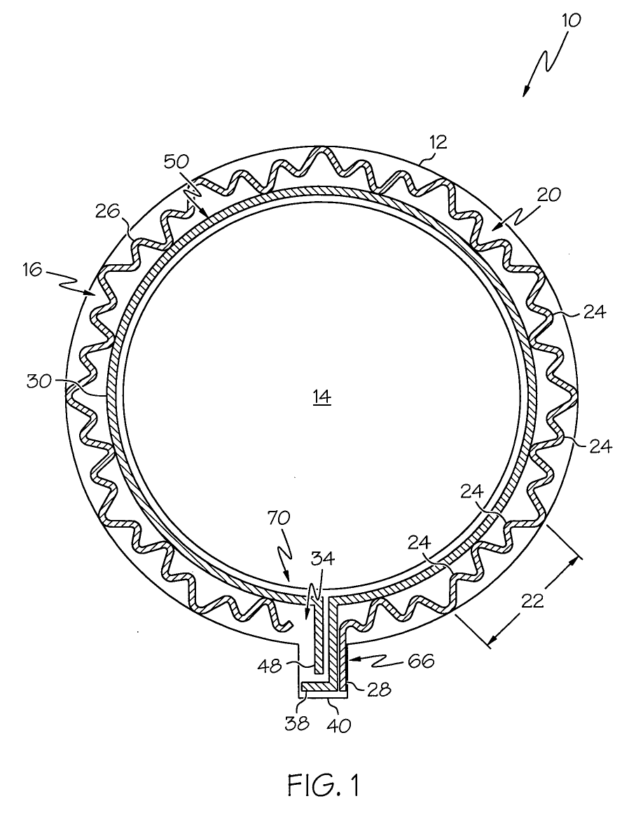

With reference to FIG. 1, a foil journal bearing 10 may have a housing 12, a hole 16 capable of receiving a shaft 14 arranged for relative coaxial rotation with respect to the housing 12, and a single spring layer 20 surrounding the shaft 14. The spring layer 20 may have a first linear spring rate formed by first pitch corrugations 22 along a length of the spring layer 20 and a second linear spring rate formed by second pitch corrugations 24 along a length of the single spring layer 20. The first pitch corrugations are coarse relative to the second pitch corrugations. Conversely, the second pitch corrugations 24 are fine relative to the first pitch corrugations 22. The single spring layer 20 may maintain a ratio of three of the second pitch corrugations 24 to each of the first pitch corrugations 22.

A top foil 30 may be positioned to extend around the shaft 14. The top foil 30 may be positioned between the spring layer 20 and the shaft 14. The single spring layer 20 may be formed by a single spring member 26 as shown in FIG. 1. A leading edge 28 of the spring 26 may be positioned in spaced relationship to a trailing edge 32 of the spring 26 to form a gap 34 for transmitting spring pre-load to the shaft 14.

The housing 12 may include a notch 40. As shown in FIG. 1, a top foil layer 50 may comprise a single top foil member 30 having a first end 38 positioned within the notch 40. The top foil member 30 may include a second end 48 opposite the first end 38. The second end 48 may be positioned within the notch 40. As shown in FIG. 1, the single spring layer 20 may be formed by a single spring member 26.

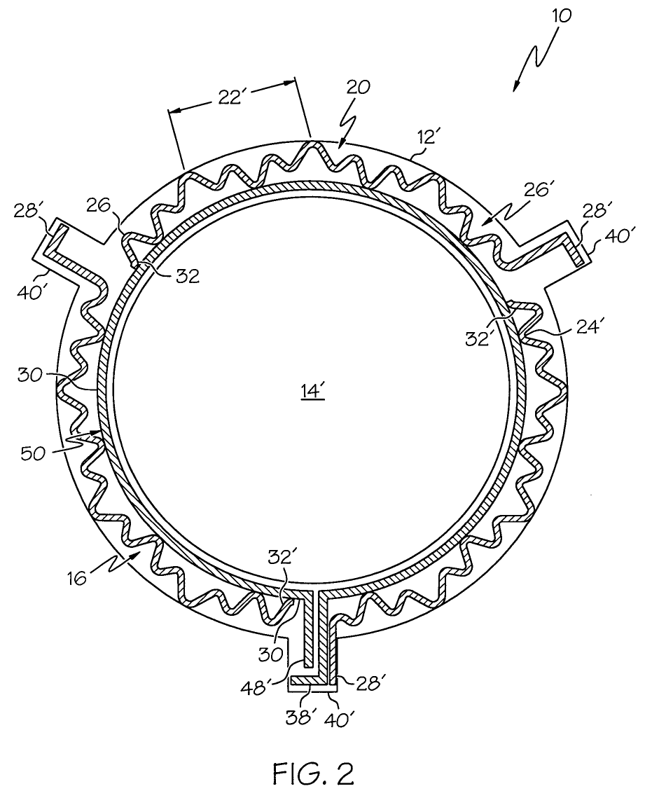

In an embodiment shown in FIG. 2, a foil journal bearing 10′ comprises a housing 12′, a shaft 14′ arranged for relative coaxial rotation with respect to the housing 12′, and a single spring layer 20′ surrounding the shaft 14′. The single spring layer 20′ may have a first linear spring rate and a second linear spring rate. The first linear spring rate may be formed by first pitch corrugations 22′ along a length of the spring layer 20′ and the second linear spring rate may be formed by second pitch corrugations 24′ along a length of the single spring layer 20′. The single spring layer 20′ may maintain a ratio of three of the second pitch corrugations 24′ to each of the first pitch corrugations 22′. The single spring layer 20′ may comprise a plurality of individual springs 26′ arranged in serial alignment around the shaft 14′. A leading edge 66 of the single spring layer 20′ is positioned in spaced relationship to a trailing edge 68 of the single spring layer 20′ to form a gap 70 for transmitting spring pre-load to the shaft. A top foil 30′ may be positioned to extend around the shaft 14′. The top foil 30′ may be positioned between the spring layer 20 and the shaft 14′.

The embodiment of the foil journal bearing 10′ as shown in FIG. 2 differs from the embodiment of FIG. 1 in that the single spring layer 20′ may be formed by a plurality of springs 26′ positioned in spaced relationship around the shaft 14′. A leading edge 28′ of each spring 26′ is positioned in spaced relationship to a trailing edge 32′ of an adjacently positioned one of the plurality of springs 26′ to form a gap 34′ between adjacent pairs of the plurality of springs 26′ for transmitting spring pre-load to the shaft 14′. As shown in FIG. 2, the housing may include a plurality of radially spaced notches 40′. The single spring layer 20′ may be formed by a plurality of springs, springs 26′ in FIG. 2 positioned in spaced relationship around the shaft 14.

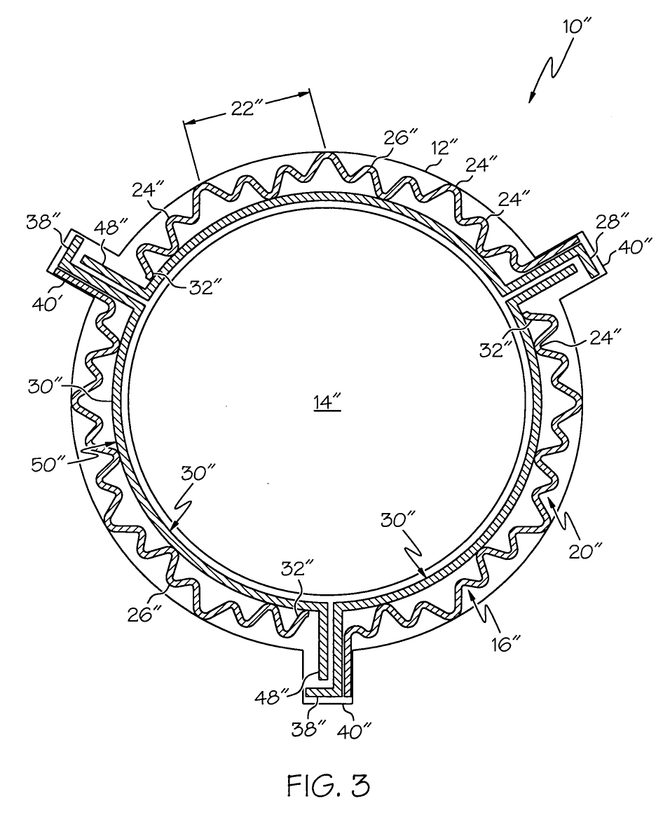

In an embodiment of the invention as shown in FIG. 3, the housing 12″ may include a plurality of radially spaced notches 40″. As shown in FIG. 3, the top foil layer 50″ of foil journal bearing 10″ may comprise a plurality of top foil members 30″ serially arranged around the shaft 14″. Each top foil member 30″ may have a first end 38″ positioned within an associated one of the spaced notches 40″. As also shown in FIG. 3, the single spring layer 20″ may comprise a plurality of spring members 26″ serially arranged around the top foil layer 50″. The single spring layer 20″ may comprise a plurality of serially arranged spring members 26″. Each spring member 26″ may have a leading edge 28″ and a trailing edge 32″. Each trailing edge 32″ may be positioned in spaced relationship to a second end 48″ of an adjacently positioned top foil member 30″ forming a gap 34″ between the trailing edge 32″ and the second end 48″ of the adjacently positioned top foil member 30″ for transmitting spring pre-load to the shaft 14″.

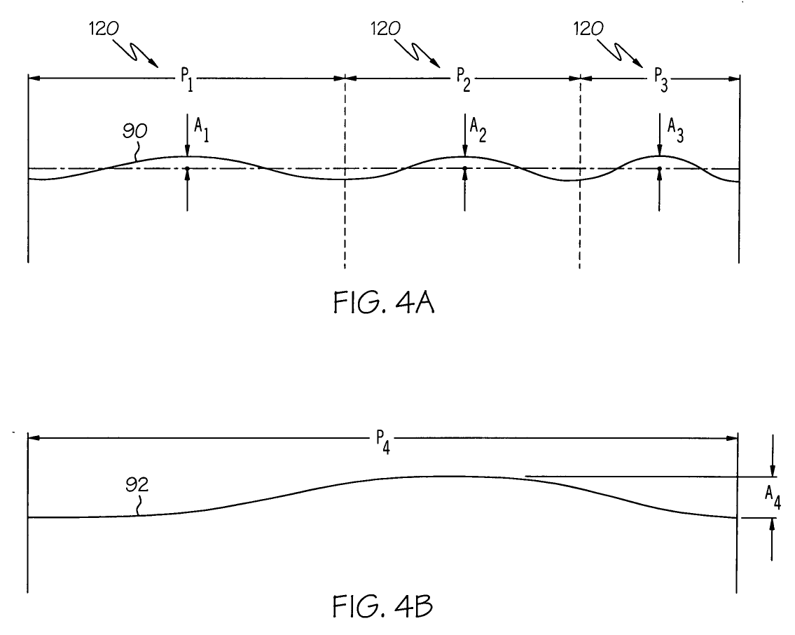

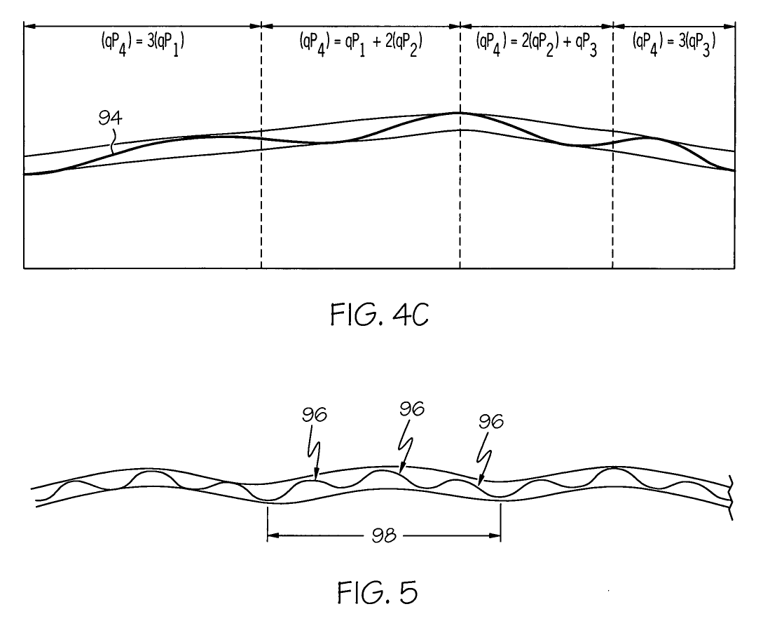

The pitch lengths of the first pitch corrugations 22, 22′, 22″ and the second pitch corrugations 24, 24′, 24″ may be variable with respect to position along the length of the spring layer 20, 20′ or 20″ in accordance with the wave forms shown in FIGS. 4a, 4b, 4c, and FIGS. 5 through 9. This may apply to all embodiments of the invention whether utilizing a single spring member 26, as shown in FIG. 1, or a plurality of spring members 26′ or 26″ as shown in FIGS. 2 and 3, respectively.

As shown generally in the wave forms shown in FIGS. 4a, 4b, 4c and FIGS. 5 through 9, pitch lengths 120 of the first pitch corrugations 22, 22′, and 22″ and the second pitch corrugations 24, 24′, and 24″ of the embodiments of FIGS. 1, 2, or 3 may be constant. Alternately, pitch lengths 120 of the first pitch corrugations 22, 22′, and 22″ and the second pitch corrugations 24, 24′, and 24″ of the embodiments of FIGS. 1, 2, or 3 may be variable with respect to position along the length of the spring layer 20, 20′, or 20″ to create areas of greater stiffness in the spring layer 20, 20′, or 20″ as desired to address vibration in the shaft 14, 14′, or 14″. FIG. 4a shows a variable second pitch bearing spring wave 90 designed for load capacity optimization. FIG. 4b shows a first pitch bearing spring wave 92 designed for pre-load to optimize damping and start-up torque. FIG. 4c shows a superimposed wave form 94 combining the second pitch and first pitch wave forms designed to provide both load capacity optimization and pre-load optimization of damping and start-up torque. In FIGS. 4a and 4b, Pᵢ=i^{th} wave pitch, Aᵢ=i^{th} wave amplitude, and qPᵢ=i^{th} wave quarter pitch. The waves 1 through 3 are the fine pitch waves and wave 4 is the coarse pitch wave. In accordance with the present invention, first (qP₄)=3(qP₁), second (qP₄)=qP₁+2(qP₂), third (qP₄)=2(qP₂)+qP₃, and fourth (qP₄)=3(qP₃).

FIG. 5 shows constant second pitch corrugations 96 and first pitch corrugations 98 in a three to one ratio according to the present invention.

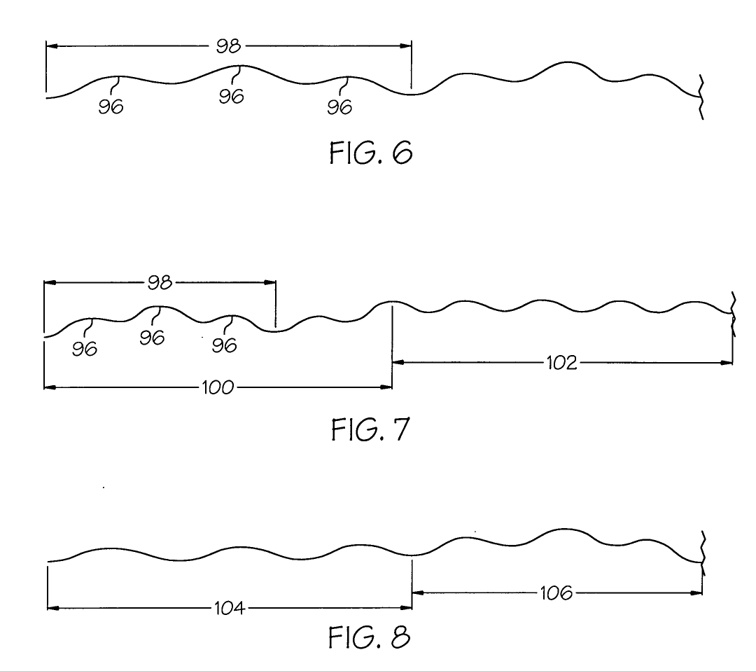

FIG. 6 shows variable second pitch corrugations 96 and first pitch corrugations 98 maintaining the three to one ratio according to the present invention providing different load bearing characteristics which may be desirable depending on the application of the present invention.

FIG. 7 shows constant second pitch corrugations with first pitch corrugation superimposition on the left side 100 of FIG. 7 but no first pitch corrugation superimposition on the right side 102 of FIG. 7. This is another possible configuration providing an adjustment of load bearing characteristics to provide greater stiffness and pre-load support on the left side 100 relative to the right side 102 which may be desirable depending on the application of the present invention.

FIG. 8 shows variable second pitch corrugations 96 with no first pitch superimposition on the left side 104 of FIG. 8 and first pitch superimposition on the right side 106 of FIG. 8. This is yet another possible configuration providing an adjustment of load bearing characteristics, i.e. areas of greater stiffness within the spring layer 26, 26′, or 26″ which may be desirable depending on the application of the present invention.

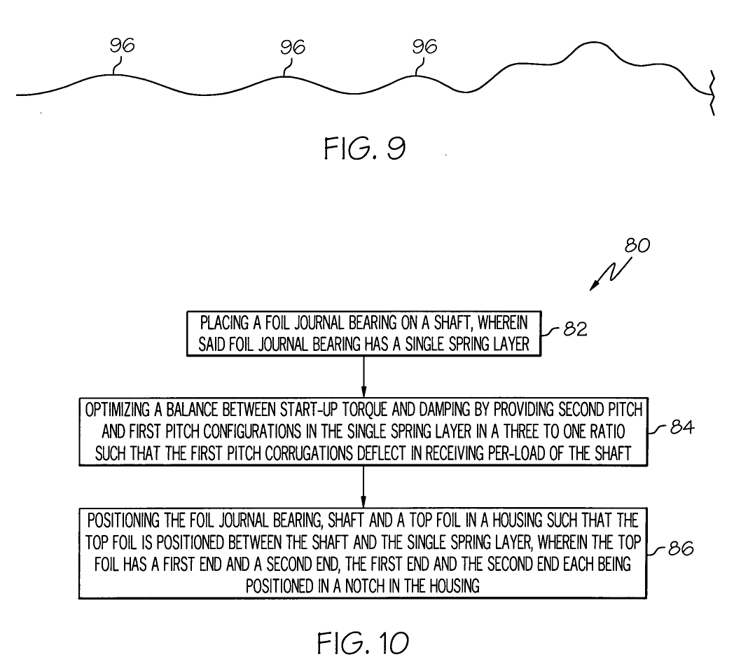

FIG. 9 shows a combination of variable and constant second pitch corrugations 96 with and without first pitch superimposition. This is still yet another possible configuration providing an adjustment of load bearing characteristics i.e. areas of greater stiffness within the spring layer 26, 26′, or 26″ which may be desirable depending on the application of the present invention.

A method 80 of damping vibration in a foil journal bearing according to the present invention, as shown in FIG. 10, may include a step 82 of placing a foil journal bearing on a shaft, wherein said foil journal bearing has a single spring layer; and a step 84 of optimizing a balance between start-up torque and damping by providing second pitch and first pitch corrugations in the single spring layer in a three to one ratio wherein the first pitch corrugations are coarse relative to the second pitch corrugations and conversely, the second pitch corrugations are fine relative to the first pitch corrugations such that the first pitch corrugations deflect in receiving pre-load of the shaft. Additionally, a step 86 may be added comprising positioning the foil journal bearing, shaft and a top foil in a housing such that the top foil is positioned between the shaft and the single spring layer, wherein the top foil has a first end and a second end, the first end and the second end each being positioned in a notch in the housing.

As can be appreciated by those skilled in the art, the present invention provides an improved apparatus and method of handling load while optimizing damping and start-up torque by utilizing a single spring layer having two linear spring rates. Use of two linear spring rates in a single spring layer can provide a bearing spring design that can be used to manufacture foil bearings that are less sensitive to natural manufacturing variation, enable specification of more practical dimensional tolerances, and do not require match-setting of parts.

It should be understood, of course, that the foregoing relates to exemplary embodiments of the invention and that modifications may be made without departing from the spirit and scope of the invention as set forth in the following claims.

We claim:

1. A foil journal bearing system comprising:
a single spring layer surrounding a shaft;
wherein said single spring layer has a first linear spring rate and a second linear spring rate;
wherein said first linear spring rate is formed by first pitch corrugations along a first length of said single spring layer;
wherein said second linear spring rate is formed by second pitch corrugations along a second length of said single spring layer; and
wherein said single spring layer maintains a ratio of three of said second pitch corrugations to each one of said first pitch corrugations.

2. The foil journal bearing system of claim 1, further comprising a top foil positioned to extend around said shaft, said top foil being positioned between said spring layer and said shaft.

3. The foil journal bearing system of claim 1 wherein said single spring layer is formed by a single spring.

4. The foil journal bearing system of claim 3 wherein a leading edge of said spring is positioned in spaced relationship to a trailing edge of said spring to form a gap for transmitting spring pre-load to said shaft.

5. The foil journal bearing system of claim 1 wherein said single spring layer is formed by a plurality of springs positioned in spaced relationship around said shaft.

6. The foil journal bearing system of claim 5 wherein a leading edge of each spring is positioned in spaced relationship to a trailing edge of an adjacently positioned one of said plurality of springs to form a gap between adjacent pairs of said plurality of springs for transmitting spring pre-load to said shaft.

7. The foil journal bearing system of claim 1 wherein pitch lengths of said second pitch corrugations and said first pitch corrugations are variable with respect to position along the length of the spring layer.

8. A foil journal bearing system comprising:
a housing;
a hole capable of receiving a shaft arranged for relative coaxial rotation within said housing;
a top foil layer disposed between said housing and said shaft; and
a single spring layer positioned between said top foil layer and said housing;
said top foil layer having a top foil member, said top foil member having a first end and a second end, said first end and said second end each being positioned within a notch in said housing;
wherein said single spring layer has a first linear spring rate and a second linear spring rate wherein said first linear spring rate is formed by first pitch corrugations along a first length of said single spring layer and said second linear spring rate is formed by second pitch corrugations along a second length of said single spring layer; and
wherein pitch lengths of said second pitch corrugations and said first pitch corrugations are variable with respect to position along the second and first lengths, respectively, of said spring layer.

9. The foil journal bearing system of claim 8 wherein said spring layer comprises a single spring member having a leading edge and a trailing edge, wherein said leading edge and said trailing edge are positioned in spaced relationship to each other forming a gap between said leading edge and said trailing edge for transmitting spring pre-load to said shaft.

10. The foil journal bearing system of claim 8 wherein said spring layer comprises a plurality of spring members serially arranged around said top foil layer.

11. The foil journal bearing system of claim 8 wherein said spring layer comprises a plurality of serially arranged spring members, each spring member having a leading edge and a trailing edge, wherein each said trailing edge is positioned in spaced relationship to said second end of an adjacently positioned top foil member forming a gap between said trailing edge and said second end of said adjacently positioned top foil member for transmitting spring pre-load to said shaft.

12. The foil journal bearing system of claim 8 wherein:
said notch in said housing is one of a plurality of radially spaced notches in said housing; and
said top foil layer comprises a plurality of top foil members serially arranged around said shaft, each said top foil member having a first end positioned within an associated one of said spaced notches.

13. The foil journal bearing system of claim 12 wherein said spring layer comprises a plurality of spring members serially arranged around said top foil layer.

14. The foil journal bearing system of claim 12 wherein said spring layer comprises a plurality of serially arranged spring members, each spring member having a leading edge and a trailing edge, wherein each said trailing edge is positioned in spaced relationship to said second end of an adjacently positioned top foil member forming a gap between said trailing edge and said second end of said adjacently positioned top foil member for transmitting spring pre-load to said shaft.

15. The foil journal bearing system of claim 8, wherein said spring layer maintains a ratio of three of said second pitch corrugations to each of said first pitch corrugations.

16. A foil journal bearing system comprising:
a housing;
a shaft arranged for relative coaxial rotation with respect to the housing; and
a single spring layer surrounding said shaft, wherein:
said single spring layer having a first linear spring rate and a second linear spring rate wherein said first linear spring rate is formed by first pitch corrugations along a first length of said single spring layer and said second linear spring rate is formed by second pitch corrugations along a second length of said single spring layer;
said single spring layer maintains a ratio of three of said second pitch corrugations to each of said first pitch corrugations;
said single spring layer comprises a plurality of individual springs arranged in serial alignment around said shaft; and
a leading edge of said single spring layer is positioned in spaced relationship to a trailing edge of said single spring layer to form a gap for transmitting spring pre-load to said shaft.

17. The foil journal bearing system of claim 16, further comprising: a top foil positioned to extend around said shaft, said top foil being positioned between said spring layer and said shaft.

18. The foil journal bearing system of claim 16 wherein said single spring layer is formed by a single spring.

19. The foil journal bearing system of claim 16 wherein said single spring layer is formed by a plurality of springs positioned in spaced relationship around said shaft.

20. The foil journal bearing system of claim 16 wherein pitch lengths of said second pitch corrugations and said first pitch corrugations are variable with respect to position along the length of the spring layer.
